(19) United States
(12) Patent Application Publication
(10) Pub. No.: US 2016/0129748 A1
(43) Pub. Date: May 12, 2016

(54) Air Spring Using Laminated Material To Reduce NVH Issues

(71) Applicant: Continental Automotive Systems, Inc., Auburn Hills, MI (US)

(72) Inventors: Christian Schallmeier, Lake Orion, MI (US); Kranti Kiran Manga, Rochester, MI (US); Marcus David Christensen, Davisburg, MI (US)

(21) Appl. No.: 14/537,926

(22) Filed: Nov. 11, 2014

(51) Int. Cl. B60G 15/10; B60G 15/12

(52) U.S. Cl. CPC B60G 15/10; B60G 15/12; B60G 2202/314; B60G 2206/7102; B60G 2206/72; B60G 2206/7104; B60G 2206/821; B60G 2206/8201

(57) ABSTRACT

An air spring includes a bellow at least partially delimiting at least one working chamber that is constructed and arranged to be filled with compressed air. A guide tube surrounds at least a portion of the bellow. A piston is associated with the bellow. The bellow is constructed and arranged to roll with respect to an outer surface of the piston and an inner surface of the guide tube. At least one of the guide tube and the piston includes a lamination comprising an inner layer of material coupled to an outer layer of material so as to cause internal friction and thus a dampening of vibrations inside the material.

### FIELD

This invention relates to an air spring for a vehicle and, in particular, to an air spring that uses laminated material to reduce noise, vibration and harshness (NVH).

### BACKGROUND

A conventional air spring is a device that is arranged between a vehicle body and chassis. The typical air spring has at least one working space that is filled with compressed air, wherein at least one working space is, in each case, delimited at least partially by movable walls in the form of rolling bellow. The working spaces are connected to one another via flow ducts, and the flow ducts have throttle valves. When the vehicle experiences spring compression and spring extension, the rolling bellow rolls both on a rotationally symmetrical contour of a roll-off piston and on an inner surface of a guide tube. The air spring has a centrally arranged hydraulic damper including a piston rod connected via and by and air spring cover to the bodywork. The piston rod is connected to a damper cylinder that is connected, via a connecting flange, to a wheel support of the chassis.

With reference to FIG. 1, the conventional guide tube is shown, generally indicated at 10. The guide tube 10, along with other hollow tubular parts of the conventional air spring, is composed of a solid or single layer metal tube 12. These components have a tendency to cause or amplify or transfer road or suspension noise/vibration into the vehicle cabin, thus causing uncomfortable NVH issues.

Thus, there is a need to provide an air spring for a vehicle that reduces or eliminates NVH issues.

### SUMMARY

An objective of the invention is to fulfill the need referred to above. In accordance with the principles of an embodiment, this objective is achieved by an air spring that includes a bellow at least partially delimiting at least one working chamber that is constructed and arranged to be filled with compressed air. A guide tube surrounds at least a portion of the bellow. A piston is associated with the bellow. The bellow is constructed and arranged to roll with respect to an outer surface of the piston and an inner surface of the guide tube. At least one of the guide tube and the piston includes a lamination comprising an inner layer of material coupled to an outer layer of material so as to cause internal friction and thus a dampening of vibrations inside the material.

In accordance with another aspect of an embodiment, an air spring includes a bellow at least partially delimiting at least one working chamber that is constructed and arranged to be filled with compressed air. A guide tube surrounds at least a portion of the bellow. A piston is associated with the bellow, with the bellow being constructed and arranged to roll with respect to an outer surface of the piston and an inner surface of the guide tube, the piston having an interior. At least one of the guide tube and the piston includes means for damping vibration.

Other objectives, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is an enlarged view of a portion of a conventional guide tube, of a conventional air spring, composed of a solid layer metal tube.

FIG. 2 is an enlarged view of a portion of a laminated guide tube of an air spring of an embodiment.

FIG. 3 is a sectional view of an air spring employing the laminated guide tube of FIG. 2, a laminated top cap, and laminated piston.

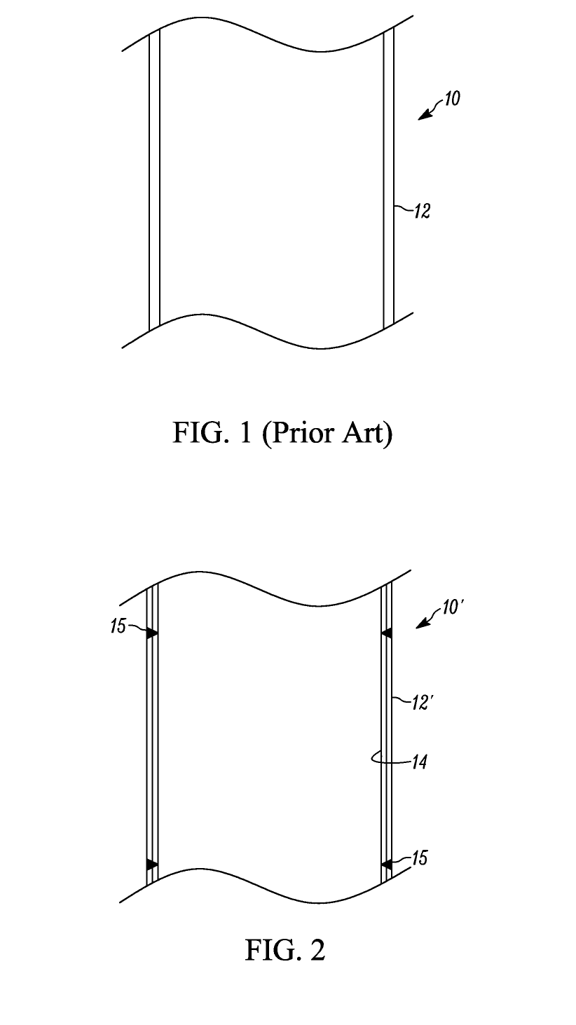

### DETAILED DESCRIPTION OF EXEMPLARY EMBODIMENTS

With reference to FIG. 2, a guide tube is shown, generally indicated at 10′, for an air spring of an embodiment. The guide tube 12 is a lamination having an outer layer 12′ and an inner layer 14. As used herein, a “lamination” is defined as two or more layers of material coupled to one another, either by bonding or by being mechanically fixed to one another. Application examples include a metal outer layer 12′ having bonded thereto, a metal or polymer inner layer 14. The polymer inner layer can comprise any kind of polymer, including a thermoplastic, thermoset, or an infusible polymer. Alternatively, a metal inner tube or layer 14 can be welded (see weld joints 15 in FIG. 2) to a metal outer tube or layer 12′, without additional bonding there-between. The metal material is preferably steel or aluminum. For example, when both layers 12′ and 14 are metal, both layers can be of the same metal material or layer 12′ can be of a metal that is different from that of layer 14.

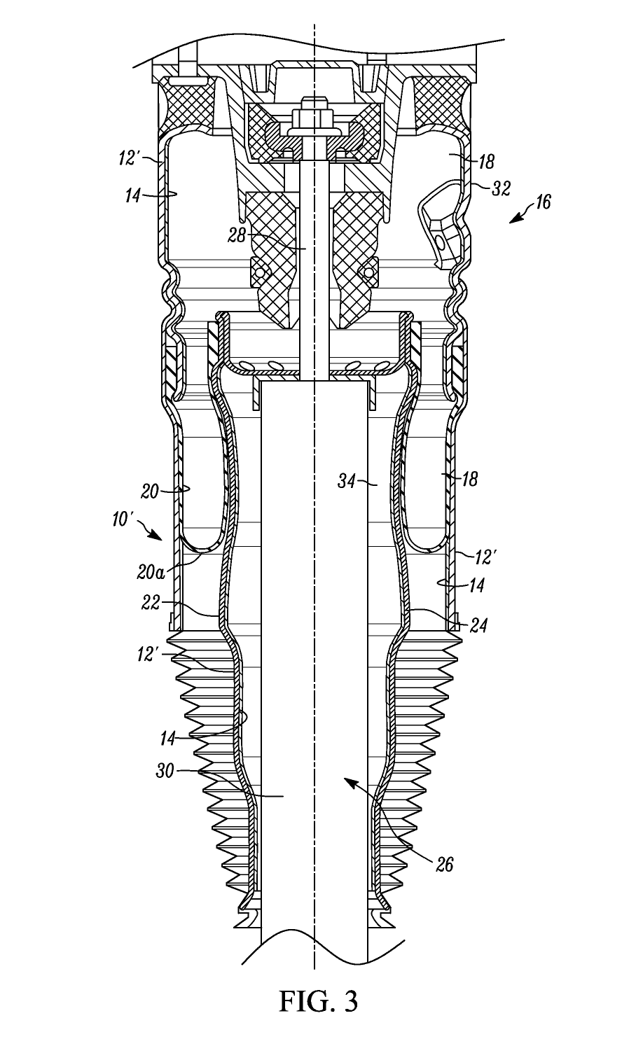

With reference to FIG. 3, the guide tube 10′ is employed in an air spring, generally indicted at 16, of an embodiment. The air spring 16 is for use in a motor vehicle and can be of the type disclosed in U.S. Pat. No. 8,474,798, the content of which is hereby incorporated by reference into this specification. Thus, the air spring 16 has at least one working chamber 18 filled with compressed air, which is at least partially delimited by an elastomer rolling bellow 20 that forms a rolled fold 20a. When the vehicle experiences spring compression and spring extension, the rolling bellow 20 rolls both on a rotationally symmetrical outer surface 22 of a roll-off piston 24 and on the inner surface of layer 14 of the guide tube 10′. Thus, the guide tube 10′ surrounds a portion of the rolling bellow 20. The air spring 16 of the embodiment has a centrally arranged hydraulic damper structure, generally indicated at 26, including a piston rod 28 preferably connected via an air spring cover (not shown) to the bodywork. The piston rod 28 is connected to a damper member or cylinder 30 that is disposed in an interior 34 of the piston 24. The damper cylinder 30 is connected, via a connecting flange (not shown) to a wheel support of the chassis in the conventional manner. A top cap 32 generally surrounds at least a portion of the piston rod 28.

Although the air spring 16 of the embodiment is of the damper type, it can be appreciated that the laminated layers 12′ and 14 can be used in guided air springs that do not have the damper structure 26.

The use of the laminated layers 12′, 14 for the guide tube 10′ causes an internal friction and thus a dampening of vibrations inside the material. Such laminated layers 12′ and 14 can be used as the material for the guide tube 10′, as well as for the top cap 32, and/or for the material of the piston 24 so as to further reduce NVH of the air spring 16 and thus reduce NVH transfer into the vehicle cabin. Advantageously, the laminated layers 12′, 14 of the various parts, do not increase the overall weight of the air spring 16 and does not require an external mass for damping.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the scope of the following claims.

What is claimed is:

1. An air spring comprising:
a bellow at least partially delimiting at least one working chamber that is constructed and arranged to be filled with compressed air,
a guide tube surrounding at least a portion of the bellow, and
a piston associated with the bellow, with the bellow being constructed and arranged to roll with respect to an outer surface of the piston and an inner surface of the guide tube, the piston having an interior,
wherein at least one of the guide tube and the piston includes a lamination comprising an inner layer of material coupled to an outer layer of material so as to cause internal friction and thus a dampening of vibrations inside the material.

2. The air spring of claim 1, further comprising:
a damper member disposed in the interior of the piston,
a piston rod coupled with the damper member, and
a cap generally surrounding at least a portion of the piston rod,
wherein at least one of the guide tube, the piston, and the cap includes the lamination.

3. The air spring of claim 1, wherein the guide tube includes the lamination.

4. The air spring of claim 1, wherein the inner layer is bonded to the outer layer.

5. The air spring of claim 1, wherein the inner layer is mechanically fixed to the outer layer.

6. The air spring of claim 4, wherein the outer layer is composed of metal and the inner layer is a polymer material bonded to the outer layer.

7. The air spring of claim 4, wherein each of the inner layer and the outer layer is composed metal.

8. The air spring of claim 6, wherein the outer layer is composed of aluminum or steel.

9. The air spring of claim 7, wherein each of the inner layer and the outer layer is composed of aluminum.

10. The air spring of claim 7, wherein each of the inner layer and the outer layer is composed of steel.

11. The air spring of claim 5, wherein the inner layer and the outer layer are composed of metal material, with the inner layer being joined to the outer layer by a weld connection.

12. The air spring of claim 11, wherein each of the inner layer and the outer layer is composed of steel.

13. The air spring of claim 11, wherein each of the inner layer and the outer layer is composed of aluminum.

14. An air spring comprising:
a bellow at least partially delimiting at least one working chamber that is constructed and arranged to be filled with compressed air,
a guide tube surrounding at least a portion of the bellow, and
a piston associated with the bellow, with the bellow being constructed and arranged to roll with respect to an outer surface of the piston and an inner surface of the guide tube, the piston having an interior,
wherein at least one of the guide tube and the piston includes means for damping vibration.

15. The air spring of claim 14, further comprising:
a damper member disposed in the interior of the piston,
a piston rod coupled with the damper member, and
a cap generally surrounding at least a portion of the piston rod,
wherein at least one of the guide tube, the piston, and the cap includes the means for damping vibration.

16. The air spring of claim 14, wherein the means for damping vibration comprises a lamination including an inner layer of material coupled to an outer layer of material so as to cause internal friction and thus a dampening of vibrations inside the material.

17. The air spring of claim 16, wherein the guide tube includes the lamination.

18. The air spring of claim 16, wherein the inner layer is bonded to the outer layer.

19. The air spring of claim 16 wherein the inner layer is mechanically fixed to the outer layer.

20. The air spring of claim 18, wherein the outer layer is composed of metal and the inner layer is a polymer material bonded to the outer layer.
